(19) United States
(12) Patent Application Publication
(10) Pub. No.: US 2023/0166571 A1
(43) Pub. Date: Jun. 1, 2023

(54) ADAPTER ASSEMBLY FOR VEHICLE BASEPLATE AND TOW BAR ASSEMBLY

(71) Applicant: Jerry A. Edwards, Portland, OR (US)

(72) Inventor: David Robinson, Vancouver, WA (US)

(21) Appl. No.: 17/538,061

(22) Filed: Nov. 30, 2021

(51) Int. Cl. B60D 1/167; B60D 1/56

(52) U.S. Cl. CPC B60D 1/1675; B60D 1/56

(57) ABSTRACT

Systems, assemblies, and an adapter arm are disclosed for connecting a tow bar assembly to a vehicle baseplate. The adapter arm comprises a forked end including a first prong and a second prong defining a slotted opening for receiving a lug connector of the tow bar assembly. The adapter arm further comprises a locking portion configured to removably secure the adapter arm to the vehicle baseplate.

### BACKGROUND

### 1. Field

Embodiments of the invention relate to vehicle towing devices. More specifically, embodiments of the invention relate to adapter assemblies for vehicle tow bars.

### 2. Related Art

Vehicle baseplates have been provided for adapting towed vehicles to tow bar assemblies. However, many of these baseplates are vehicle specific such that vendors must carry a large number of different baseplates. Further, many of the vehicle baseplates are configured to adapt to specific types of tow bar assemblies. Accordingly, a large number of different adapters are required to adapt the vehicle-specific baseplates to the tow bar assemblies. For example, if a user purchases an incompatible tow bar, an adapter may be required to adapt the vehicle baseplate to fit the tow bar. Further still, such adapters may be incompatible with certain types of tow bar assemblies.

As a result of the variation between the vehicle-specific baseplates, suppliers of said baseplates must hold a large number of baseplates in inventory including baseplates for each vehicle type as well as for each type of tow bar assembly, which significantly augments the number of different baseplates that are required.

### SUMMARY

Embodiments of the invention solve the above-mentioned problems by providing an adapter arm for adapting various types of tow bar assemblies to a vehicle baseplate. In some embodiments, the adapter arm comprises a forked end including a first prong and a second prong defining a slotted opening for receiving a lug connector of the tow bar assembly. The adapter arm further comprises a locking portion configured to removably secure the adapter arm to the vehicle baseplate. Accordingly, by adapting the vehicle baseplate to a wide variety of different styles of tow bar assemblies, the inventory issues described above are resolved.

A first embodiment of the invention is directed to a removable adapter arm for adapting a tow bar assembly to a vehicle baseplate, the adapter arm comprising a first end comprising a forked portion having a first prong and a second prong, the first prong and the second prong of the forked portion defining a slotted opening for receiving a lug connector of the tow bar assembly, a through-hole extending through the first prong and the second prong configured to receive a connector pin to rotatably secure the first end of the adapter arm to the tow bar assembly, and a second end comprising a locking portion configured to be inserted into a keyway of a vehicle baseplate and rotated to lock the second end of the adapter arm to the vehicle baseplate.

A second embodiment of the invention is directed to an adapter assembly for adapting a tow bar assembly to a vehicle baseplate, the adapter assembly comprising two adapter arms, each adapter arm comprising a first end comprising a forked portion having a first prong and a second prong, the first prong and the second prong of the forked portion defining a slotted opening for receiving a lug connector of the tow bar assembly, a through-hole extending through the first prong and the second prong configured to receive a connector pin to rotatably secure the first end of the adapter arm to the tow bar assembly, and a second end comprising a locking portion configured to be inserted into a keyway of a vehicle baseplate and rotated to lock the second end of the adapter arm to the vehicle baseplate, and a pin assembly for each adapter arm disposed between the first end and the second end of the adapter arm for locking rotation of the adapter arm respective to the vehicle baseplate.

A third embodiment of the invention is directed to a towing adapter system comprising a tow bar assembly, a vehicle baseplate secured to a front end of a towed vehicle, the vehicle baseplate comprising a vehicle-specific attachment portion for securing the vehicle baseplate to the front end of the towed vehicle, and a connector portion defining a keyway, an adapter assembly for adapting the tow bar assembly to the vehicle baseplate, the adapter assembly comprising two adapter arms disposed between the tow bar assembly and the vehicle baseplate, each of the adapter arms comprising a first end comprising a forked portion having a first prong and a second prong, the first prong and the second prong of the forked portion defining a slotted opening for receiving a lug connector of the tow bar assembly, a through-hole extending through the first prong and the second prong configured to receive a connector pin to rotatably secure the first end of the adapter arm to the tow bar assembly, and a second end comprising a locking portion configured to be inserted into the keyway of a vehicle baseplate and rotated to lock the second end of the adapter arm to the vehicle baseplate, and a pin assembly for each adapter arm disposed between the first end and the second end of the adapter arm for locking rotation of the adapter arm respective to the vehicle baseplate.

Additional embodiments of the invention are directed to a method of connecting one or more adapter arms between a tow bar assembly and a vehicle baseplate.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the invention will be apparent from the following detailed description of the embodiments and the accompanying drawing figures.

### BRIEF DESCRIPTION OF THE DRAWING FIGURES

Embodiments of the invention are described in detail below with reference to the attached drawing figures, wherein:

FIG. 1 depicts a towing system relating to some embodiments of the invention;

FIG. 2 depicts a top view of a towing system relating to some embodiments of the invention;

FIG. 3 depicts an isometric view of an adapter assembly relating to some embodiments of the invention;

FIG. 4A depicts a backside isometric view of an adapter arm inserted into a connector portion of a vehicle baseplate relating to some embodiments of the invention;

FIG. 4B depicts a side view of an adapter arm inserted into a connector portion of a vehicle baseplate relating to some embodiments of the invention;

FIG. 5A depicts an adapter assembly attached to a triple lug connector of a tow bar assembly relating to some embodiments of the invention;

FIG. 5B depicts an adapter assembly attached to a single lug connector of a tow bar assembly relating to some embodiments of the invention;

FIGS. 6A-C depict a plurality of views of an adapter arm relating to various embodiments of the invention; and

FIG. 7 depicts an exemplary method for connecting an adapter assembly to a vehicle baseplate and a tow bar assembly.

The drawing figures do not limit the invention to the specific embodiments disclosed and described herein. The drawings are not necessarily to scale, emphasis instead being placed upon clearly illustrating the principles of the invention.

### DETAILED DESCRIPTION

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the invention. The following detailed description is, therefore, not to be taken in a limiting sense. The scope of the invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the technology can include a variety of combinations and/or integrations of the embodiments described herein.

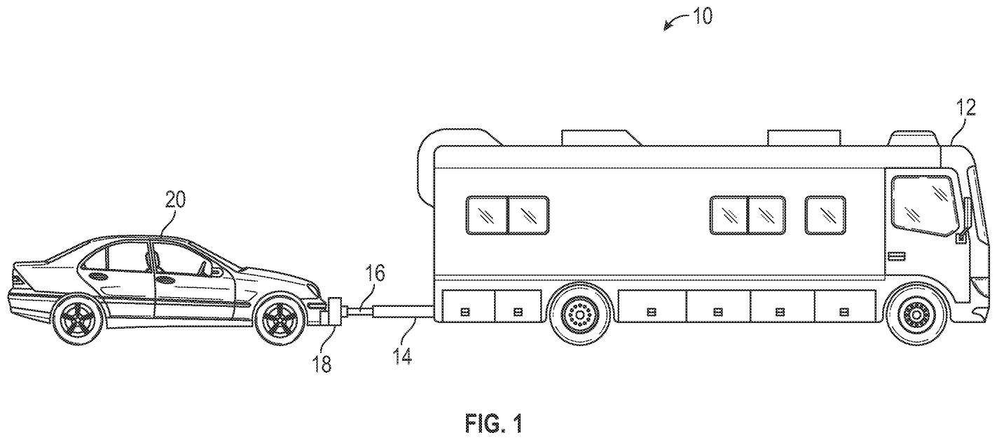

Turning first to FIG. 1, a towing system 10 is depicted relating to some embodiments of the invention. In some embodiments, the towing system 10 includes a towing vehicle 12, a tow bar assembly 14, an adapter assembly 16, a vehicle baseplate 18, and a towed vehicle 20, as shown. In some embodiments, the tow bar assembly 14 may be removably secured to a rear portion of the towing vehicle 12, which in some embodiments, may be a recreational vehicle or truck. However, it should be understood that a variety of different types of vehicles are contemplated as the towing vehicle 12 in some embodiments. Similarly, in some embodiments, the vehicle baseplate 18 may be secured to a front end of the towed vehicle 20.

In some embodiments, the towed vehicle may be any type of automobile such as a van or sedan-style vehicle. Further still, in some embodiments, the towed vehicle 20 may be a non-traditional vehicle such as an all-terrain vehicle (ATV), a motorcycle, or a mobile equipment such as a tractor. In some embodiments, the vehicle baseplate 18 may be removably attached to the towed vehicle 20. However, embodiments are contemplated in which at least a portion of the vehicle baseplate 18 is permanently attached to the front end of the towed vehicle 20. For example, in some embodiments, the vehicle baseplate 18 may be bolted, welded, or permanently affixed in another suitable way to a front bumper of the towed vehicle.

In some embodiments, the adapter assembly 16 may be disposed between the tow bar assembly 14 and the vehicle baseplate 18. Accordingly, in some embodiments, the adapter assembly 16 may be removably attached to each of the tow bar assembly 14 and the vehicle baseplate 18 such that the towed vehicle 20 can be optionally disconnected from the tow bar assembly 14. In some embodiments, the towing vehicle 12 pulls the towed vehicle 20 using the tow bar assembly 14, which is connected to the towed vehicle 20 through the adapter assembly 16 and the vehicle baseplate 18.

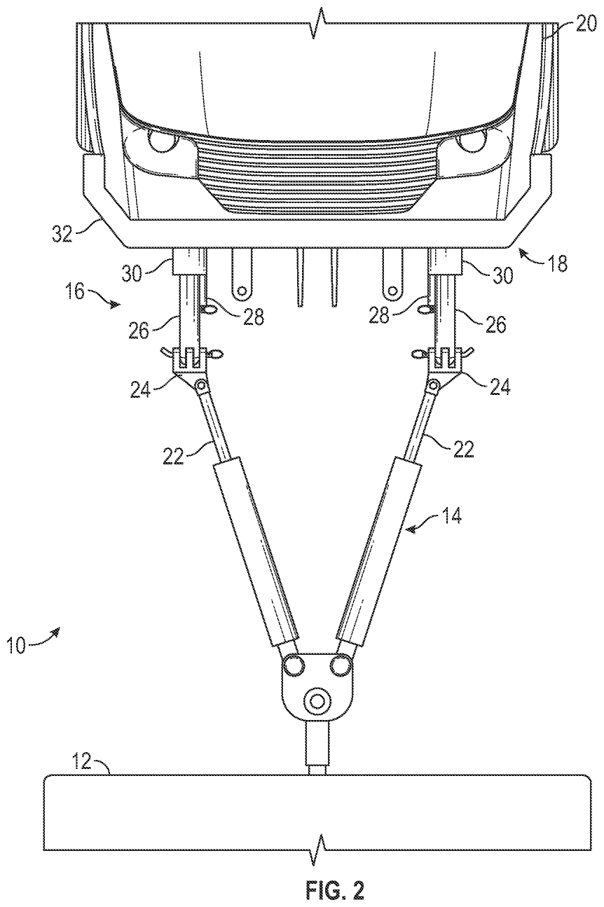

Turning now to FIG. 2, a top view of the system 10 is depicted relating to some embodiments of the invention. Here, a back end of the towing vehicle 12 is shown with the attached tow bar assembly 14. For example, the tow bar assembly 14 may be removably secured to a trailer hitch (not shown) of the towing vehicle 12. The tow bar assembly 14 comprises tow bar arms 22, as shown. In some embodiments, two tow bar arms 22 may be included for distributing the towing load. In some embodiments, the tow bar arms 22 comprise a telescoping section, as shown, for adjusting a length of the tow bar arms 22. However, it should be understood that various other means of adjusting the length of the tow bar arms 22 are also contemplated. The tow bar assembly 14 further comprises lug connectors 24. In some embodiments, a lug connector 24 may be disposed at an end of each of the tow bar arms 22, as shown.

In some embodiments, the lug connector 24 may be bolted or pinned to the end of the tow bar arm 22. Further, embodiments are contemplated in which the lug connector 24 may be attached using various other connection means such as welding or another suitable fastening technique. It should be understood that various different types of tow bar assemblies may be included. For example, in some embodiments, tow bar assembly 14 may comprise single lug connectors. Alternatively, in some embodiments, tow bar assembly 14 may comprise multiple lug connectors such as triple lug connectors, as will be described in further detail below.

In some embodiments, the adapter assembly 16 comprises one or more adapter arms 26. In some embodiments, the adapter assembly 16 comprises two adapter arms 26, as shown. For example, each adapter arm 26 may comprise a cylindrical portion extending over a length of the adapter arm 26. In some embodiments, the adapter arms 26 may be manufactured from a single cylindrical bar. In some embodiments, the adapter arms 26 may have a circular, elliptical, rectangular, or square cross-section. Accordingly, the adapter arm 26 may be subtractively machined to include the features described herein, for example, using a lathe or other subtractive manufacturing technique. Further, embodiments are contemplated in which the adapter arm 26 is additively manufactured, for example, using a 3-D printing technique or other suitable additive technique. In some embodiments, the adapter arm 26 may comprise a steel material. Alternatively, embodiments are contemplated in which the adapter arm 26 is produced from other materials such as, aluminum, titanium, or other suitable metals, ceramics, or composite materials. Additionally, in some embodiments, an end of each adapter arm 26 may be configured to interface with the lug connector 24 of the tow bar assembly 14, as shown. For example, one or more lugs of the lug connector 24 may fit within or around the end of the adapter arm 26. In some embodiments, the lug connector 24 may be pinned or bolted to the end of the adapter arm 26, as will be described in further detail below.

In some embodiments, the adapter assembly 16 further comprises a pin assembly 28 disposed on a side of each adapter arm 26. In some embodiments, the pin assembly 28 may be a spring-loaded spring assembly for removably securing the adapter arm 26 to a portion of the vehicle baseplate 18. For example, the pin assembly 28 may interface with a connector portion 30 of the vehicle baseplate 18. In some embodiments, the connector portion 30 may comprise a hollow portion for receiving an end of the adapter arm 26, as shown. In some embodiments, the connector portion 30 may be cylindrical or rectangular, and cooperate with a similarly shaped adapter arm 26. In some embodiments, the connector portion 30 may have a circular, elliptical, rectangular, or square cross-section. In addition to the connector portion 30, the vehicle baseplate 18 may further comprise a vehicle-specific attachment portion 32.

In some embodiments, the vehicle-specific attachment portion 32 may be configured to attach to a front end of the towed vehicle 20, as shown. For example, the vehicle-specific attachment portion 32 may be welded or bolted directly to the frame of the towed vehicle. Alternatively, in some embodiments, the vehicle-specific attachment portion 32 may be secured to a vehicle unibody or to the front bumper of the towed vehicle 20. It should be understood that the size and shape of the vehicle-specific attachment portion 32 may be selected to fit a certain type of vehicle. For example, the vehicle-specific attachment portion 32 may be designed to fit onto a front portion of the frame of the towed vehicle 20. Embodiments are contemplated in which the vehicle-specific attachment portion 32 may be permanently fixed to the towed vehicle 20. Alternatively, in some embodiments, the vehicle-specific attachment portion 32 may be removably attached to the towed vehicle 20 such that the vehicle baseplate 18 may be optionally removed and reattached.

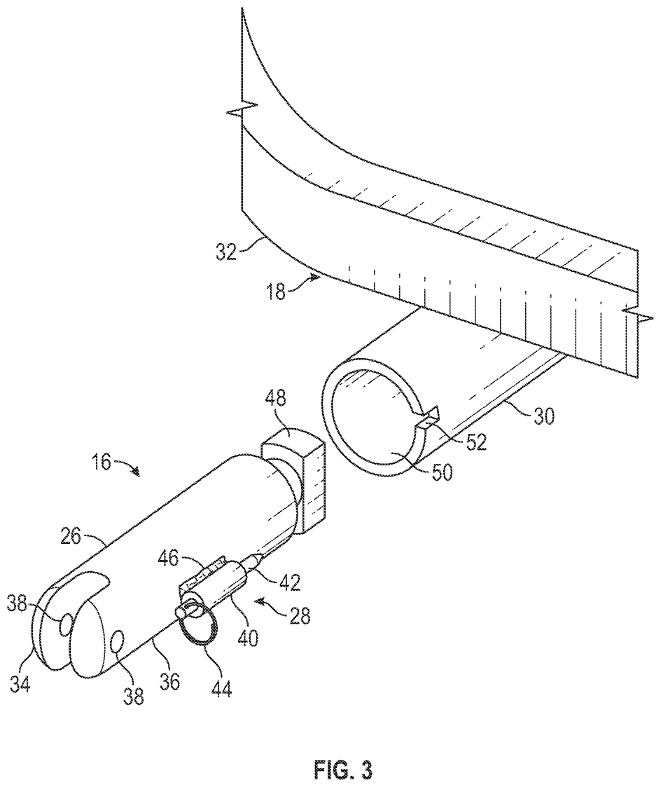

Turning now to FIG. 3, an isometric view of the adapter assembly 16 and the vehicle baseplate 18 is depicted relating to some embodiments of the invention. Here, the adapter arm 26 may include a first end with a forked portion, as shown, comprising a first prong 34 and a second prong 36 defining a slotted opening for receiving a lug of the lug connector 24 of the tow bar assembly 14. In some embodiments, each of the first prong 34 and the second prong 36 may comprise a through-hole 38 for receiving a pin, bolt, or other suitable type of fastener to thereby secure the adapter arm 26 to the lug connector 24. In some embodiments, the adapter arm 26 may be pivotably attached to the lug connector 24 such that the adapter arm 26 may rotate along at least one axis. In some embodiments, allowing rotation between the adapter arm 26 and the tow bar assembly 14 may alleviate stress associated with a difference in height between the towing vehicle 12 and the towed vehicle 20, for example, when driving over rough terrain or a hill.

The pin assembly 28 of the adapter assembly 16 may be secured to a side of the adapter arm 26, as shown, and may include a pin housing 40, a pin 42, and a pin ring 44. In some embodiments, the pin housing 40 may be secured to the adapter arm 26 with a weld joint 46, as shown. However, embodiments are contemplated in which other suitable means of permanent or non-permanent attachment may be used to affix the pin assembly 28 to the adapter arm 26, such as for example, bolting, brazing, or soldering. In some embodiments, the pin 42 is disposed within the pin housing 40, as shown. As described above, the pin assembly 28 may be a spring-loaded pin assembly. Accordingly, embodiments are contemplated in which the pin assembly 28 further comprises a biasing means, such as a spring, for applying a biasing force to the pin 42. In some embodiments, a spring applies a biasing force to the pin 42 in the direction of the vehicle baseplate 18. The pin ring 44 may be attached to an end of the pin 42, as shown, for allowing an operator to disengage the pin assembly 28 by gripping and pulling the pin ring 44 and for preventing the pin 40 from being pushed out of the pin housing 40 by the spring force.

In some embodiments, the pin 42 is configured such that the pin 42 has a limited range of motion, for example, so the pin 42 may be removed from the recessed portion 52 but still remain partially within the pin housing 40. In some embodiments, the pin ring 44 prevents the pin 42 from being removed from the pin housing 40. Here, the pin ring 44 may have a diameter such that it is unable to fit through the pin housing 40. Accordingly, embodiments are contemplated in which the pin 42 may be removed from the pin housing 40 by first removing the pin ring 44. In some embodiments, it may be desirable to remove the pin 42, for example, to replace the spring or to perform other maintenance operations. Further, in some such embodiments, the pin 42 may include a ridge (not shown) which may be internal to the pin housing 40 to prevent the pin 42 from being fully removed. Alternatively, embodiments are contemplated in which the pin 42 may be selectively removed entirely from the pin housing 40.

The adapter assembly 16 further comprises a locking portion 48 disposed at a second end of the adapter arm 26, as shown. The locking portion 48 may be configured to be inserted into a keyway 50 of the connector portion 30 of the vehicle baseplate 18. In some embodiments, the keyway 50 may include a circular opening on the front side, as shown, and a narrower opening on a rear side, as will be described in further detail below. The connector portion 30 may additionally comprise a recessed portion 52 for receiving the pin 42 of the pin assembly 28 therein. Accordingly, the recessed portion 52 may comprise a cutaway notch along an outer wall of the connector portion 30, as shown. Alternatively, in some embodiments, the recessed portion 52 may comprise a recessed hole or some other cavity within the outer wall of the connector portion 30 for receiving the pin 42. The connector portion 30 may be secured to a bottom surface of the vehicle-specific attachment portion 32 of the vehicle baseplate 18.

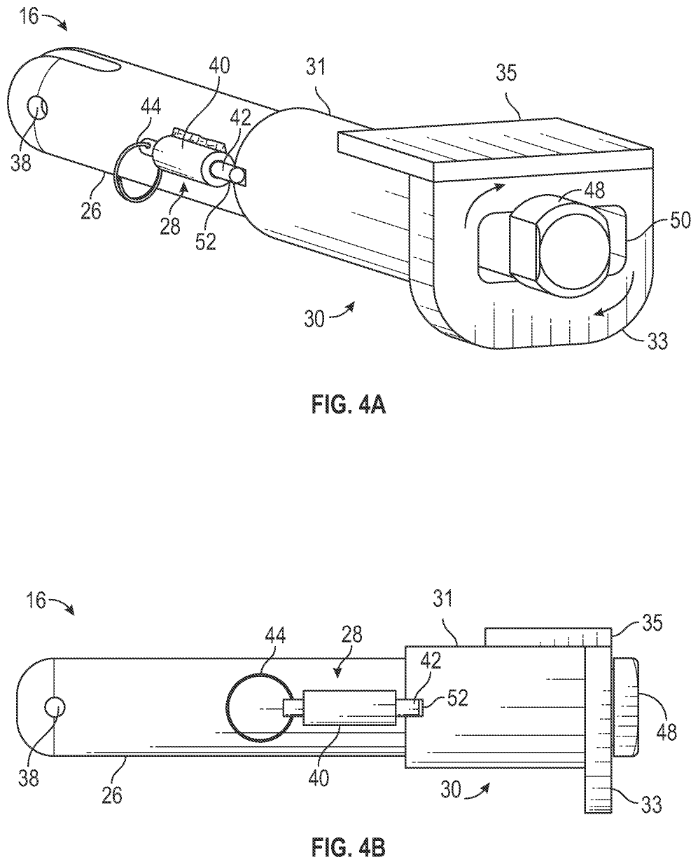

Turning now to FIG. 4A, a rear isometric view of the adapter assembly 16 including the adapter arm 26 inserted into the connector portion 30 of the vehicle baseplate 18 is depicted relating to some embodiments of the invention. In some embodiments, the connector portion 30 comprises a cylindrical section 31 for receiving the adapter arm 26 therein. Further, in some embodiments, the connector portion 30 also comprises a rear plate 33 on the rear side and a top plate 35. In some embodiments, top plate 35 may comprise an upper flat surface for connecting to the vehicle-specific portion 32 of the vehicle baseplate 18. For example, in some embodiments, the top plate 35 may be welded to the vehicle-specific portion 32. In some embodiments, rear plate 33 may include keyway 50, having a shape for locking the locking portion 48 therein. In some embodiments, keyway 50 may be rectangularly shaped.

In some embodiments, to removably attach the adapter assembly 16 to the vehicle baseplate 18, the adapter arm 26 may be inserted into the keyway 50 of the connector portion 30 such that the locking portion 48 of the adapter arm 26 extends through the entire keyway 50. In some embodiments, the adapter arm 26 may be rotated prior to insertion such that the locking portion 48 fits through the keyway 50. After being inserted into the keyway 50, the locking portion 48 may extend out the rear side through rear plate 33 of the connector portion 30 and the adapter arm 26 may then be rotated. Rotation of the adapter arm 26 may cause the locking portion 48 to be engaged to prevent removal of the adapter arm 26 from the connector portion 30. In some embodiments, the adapter arm 26 may be rotated in the direction of rotation, R, indicated on FIG. 4A. Alternatively, in some embodiments, the adapter arm 26 may be rotated in a reverse direction. In some embodiments, the adapter arm may be rotated about 90 degrees to lock the locking portion 48. In some embodiments, the adapter arm may be rotated about 45-135 degrees to lock the locking portion 48. In some embodiments, the locking portion 48 may be shaped to have two flat edges and two rounded edges, as seen in FIG. 3.

In some embodiments, the locking portion 48 may have any geometrical configuration to engage with the rear opening of connection portion 30 or an internal keyway of the connector portion 30. As such, embodiments are contemplated in which the keyway 50 may be a fully internal keyway such that, when attached, the adapter arm 26 does not protrude completely through the connector portion 30. In such embodiments, the internal keyway is sized such that the locking portion 48 could be engaged to lock into the internal keyway 50. Here, the internal keyway may comprise two larger diameter sections as well as a intermediate smaller diameter section (not shown) that engages with the locking portion 48 after rotation. In some such embodiments, the internal keyway may be substantially similar to the keyway 50 shown, but may be internal to the connector portion 30 such that the internal keyway would not be visible in FIG. 4A. Accordingly, in such embodiments, the connector portion 30 may comprise a internal opening within the wall, such as created by milling out a portion of the wall, for receiving the locking portion 48 of the adapter arm 26.

In some embodiments, the recessed portion 52 may be sized to receive an end of the pin 42, as shown, to further lock the adapter arm 26 to the connector portion 30. Here, the pin 42 may automatically engage when the adapter arm 26 is rotated a particular amount, such as 90 degrees, such that the pin 42 lines up with the recessed portion 52 of the connector portion 30. Accordingly, the adapter arm 26 may be removed by pulling the pin ring 44 such that the pin 42 is retracted and disengaged from the recessed portion 52, and rotating the adapter arm 26 such that the locking portion 48 fits back through the keyway 50. It should be understood that the connector portion 30 may also be secured to the vehicle-specific attachment portion 32 of the vehicle baseplate 18, as described above, however, the vehicle-specific attachment portion 32 is not shown in FIG. 4A such that the adapter arm 26 is visible.

In some embodiments, the shape of the opening of the keyway 50 on the back side may be different than the cylindrical opening on the front side, as shown. Here, the keyway 50 on the back side may include a similar shape as the locking portion 48 which is narrower than the cylindrical portion such that the locking portion 48 fits through the keyway 50 at a certain range of angles but does not fit through the keyway 50 after being rotated a particular amount. Accordingly, if the adapter arm 26 is attempted to be removed while the locking portion is engaged, the locking portion 48 will contact the connector portion 30 on the edge of the keyway 50 to block movement of the adapter arm 26.

Turning now to FIG. 4B, a side view of the adapter arm 26 inserted into the connector portion 30 of the vehicle baseplate 18 is depicted relating to some embodiments of the invention. Here, the locking portion 48 of the adapter arm 26 extends through the connector portion 30, as shown. For example, the adapter arm 26 may be inserted into the cylindrical section 31 of the connector portion 30 and extend through the rear plate 33 of the connector portion 30. An arrow is shown indicating the direction of a force, F, applied to the pin ring 44 to disengage the pin assembly 28. Accordingly, when the pin ring 44 is pulled in this direction, the pin 42 moves with respect to the pin housing 40 and the end of the pin 42 is removed from the recessed portion 52 (not shown).

In some embodiments, a biasing means may be included within the pin assembly 28, as described above. For example, a spring may be included within the pin housing 40. Accordingly, in some embodiments, the spring may be disposed within the pin housing 40 and secured to a portion of the pin 42 such that the spring can provide a biasing force acting against the arrow F shown in FIG. 4B. Here, the pin housing 40 may include a reduced diameter section for receiving an end of the spring. Further, the pin 42 may include an increased diameter section for attaching to the spring. However, it should be understood that embodiments are contemplated including a variety of other techniques for biasing the pin assembly 28 such that the pin 42 is pushed into the recessed portion 52 of the connector portion 30.

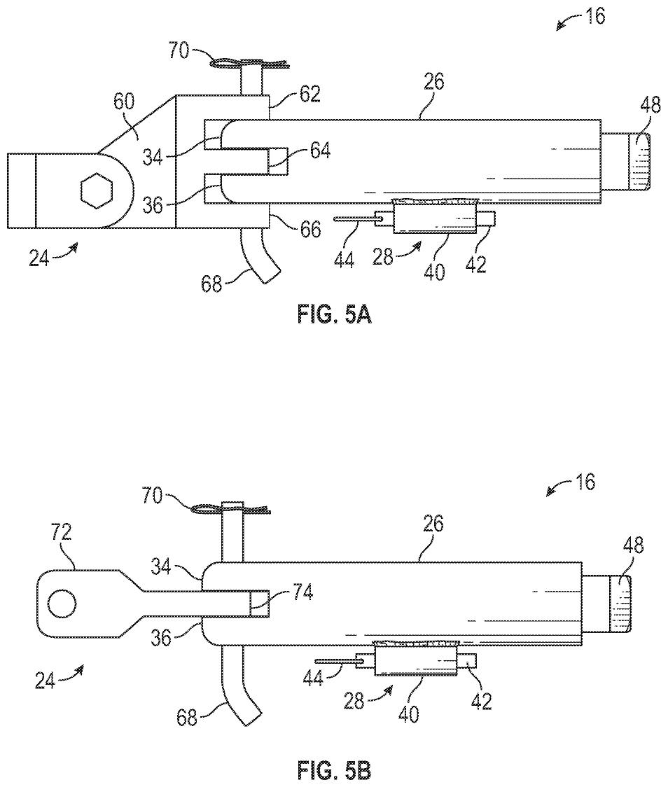

Turning now to FIG. 5A-B, the adapter assembly 16 is depicted along with two respective types of lug connectors relating to some embodiments. FIG. 5A shows the adapter assembly 16 attached to the lug connector 24 of the tow bar assembly 14. Here, the lug connector 24 comprises a triple lug connector 60, as shown. Accordingly, the triple lug connector 60 comprises a first lug 62, a second lug 64, and a third lug 66. In some embodiments, the adapter arm 26 is configured to interface with the lug connector 24 such that the first prong 34 fits between the first lug 62 and the second lug 64 and the second prong 36 fits between the second lug 64 and the third lug 66, as shown. Further, the second lug 64 may be a central lug which fits into the slotted opening defined by the first prong 34 and the second prong 36. In some embodiments, a clevis pin 68 may be included for securing the adapter arm 26 to the lug connector 24. For example, the clevis pin 68 may be inserted into the through-hole 38 of the adapter arm 26 and into a hole on each of the lugs 62, 64, and 66. In some embodiments, a cotter pin 70 or split-pin may be included for inserting into an end of the clevis pin 68 configured to lock the clevis pin 68 in place.

In some embodiments, the adapter arm 26 may be rotatably connected to the lug connector 24 such that the adapter arm 26 can rotate freely along at least one axis. For example, the adapter arm 26 may rotate along the pinned connection of the clevis pin 68. In some embodiments, the through-hole 38 of the adapter arm 26 may be sized to receive the clevis pin 68 with a clearance fit such that the clevis pin 68 may be easily inserted to quickly connect the adapter arm 26 to the lug connector 24 of the tow bar assembly 14.

FIG. 5B again shows the adapter arm 26 connected to the lug connector 24 of the tow bar assembly 14. However, here, the lug connector 24 comprises a single lug connector 72. The single lug connector 72 comprises a single lug 74 which fits into the slotted opening defined by the first prong 34 and the second prong 36. Accordingly, in some embodiments, the slotted opening of the adapter arm 26 may be sized for receiving either of the single lug 74 or the central lug 64. Accordingly, the length and width of the slotted opening may be selected specifically based on a size and shape of the lug connector 24, as will be described in further detail below.

In some embodiments, the single lug connector 72 includes a hole for receiving the clevis pin 68 which may be locked in place using the cotter pin 70, as described above. Further, in some embodiments, the adapter arm 26 may be rotatably attached for allowing rotation along at least one axis. Accordingly, the adapter arm 26 may adapt to varying vehicle heights. For example, if the towed vehicle 20 is significantly shorter than the towing vehicle 12, the adapter arm 26 may rotate downward to accommodate the height difference.

In some embodiments, the adapter arm 26 is configured to accommodate either type of lug connector 24 in addition to other types of lug connectors. For example, lug connectors including a higher number of lugs or lugs of an increased length. Further, embodiments are contemplated in which the adapter arm 26 may be connected to the triple lug connector 60, removed, then connected to the single lug connector 72. Accordingly, for example, the adapter arm 26 may be initially connected to the triple lug connector 60 on a first towing vehicle, then the adapter arm 26 may be disconnected and connected to a single lug connector 72 which is secured to a second towing vehicle. Here, the adapter arm 26 may remain attached to the vehicle baseplate 18 of the same towed vehicle 20 during the transfer between different tow bar assemblies.

In some embodiments, the adapter assembly 16 described herein greatly reduces the number of vehicle-specific baseplates that a supplier will need to keep in inventory because the adapter arm 26 is configured to be attached to the various styles of tow bar connectors. Accordingly, the suppliers may carry the vehicle-specific baseplate 18, as described herein, which can be adapted to any style of tow bar connector, such as the triple lug connector 60 and the single lug connector 72 by the adapter arm 26. As such, a large number of different tow bar-specific vehicle baseplates are not needed and do not need to be held in inventory.

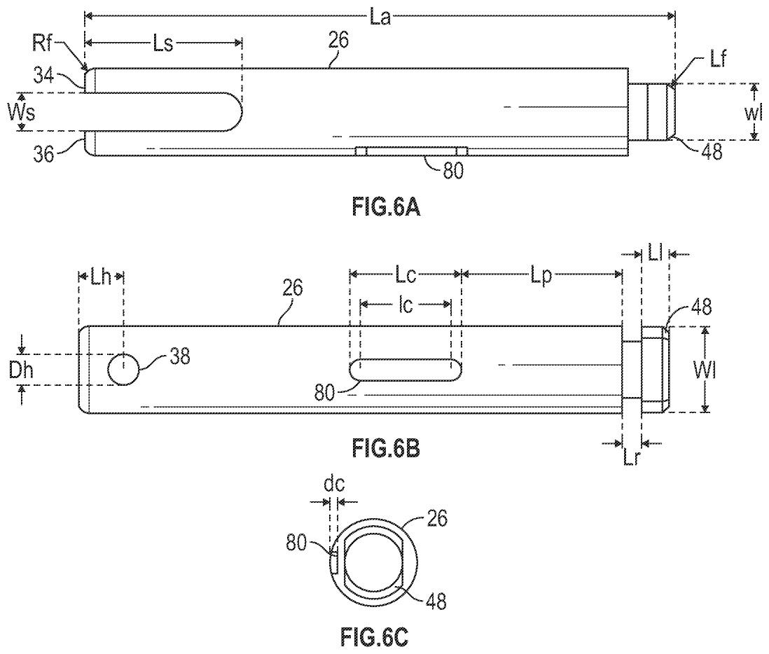

Turning now to FIGS. 6A-C, a plurality of views of the adapter arm 26 are depicted relating to some embodiments of the invention. Specifically, FIG. 6A depicts a top view of the adapter arm 26. In some embodiments, a length, Ls, of the slotted portion of the adapter arm 26 from the first end of the adapter arm 26 to the inner edge of the slotted portion may be approximately 2.7688 inches. In some embodiments, the length, Ls, may be between about 2.7 inches to about 2.8 inches. In some embodiments, the length, Ls, may be between about 1 inch to about 4 inches. Further, a width, Ws, of the opening in the slotted portion may be approximately 0.5375 inches. In some embodiments, the width, Ws, may range from about 0.45 inches to about 0.65 inches. In some embodiments, the width, Ws, may be about 0.2 inches to about 0.8 inches. In some embodiments, an edge of the adapter arm at the forked end may be chamfered or filleted, as shown. Accordingly, a radius, Rf, of the filleted edge may be approximately 0.1969 inches. In some embodiments, a radius, Rf, of the filleted edge may be about 0.1 inches to about 0.3 inches.

In some embodiments, the locking portion 48 may have a smaller width, wl, of about 1 inch. In some embodiments, the width, wl, may range from about 0.9 inches to about 1.1 inches. In some embodiments, the width, wl, may be about 0.5 inches to about 1.5 inches. Further, in some embodiments, at least one edge of the locking portion 48 may be filleted or chamfered, as shown, with a chamfer length, Lf, of about 0.125 inches at an angle of about 45 degrees. In some embodiments, the chamfer length, Lf, may be about 0.1 inches to about 0.3 inches at an angle of about 30-60 degrees. Here, the chamfered edges of the locking portion 48 may be used to guide the adapter arm 26 into the keyway 50 of the connector portion 30 for attaching the adapter assembly 16 to the vehicle baseplate 18. In some embodiments, the adapter arm 26 includes a cutaway portion 80 for receiving the pin assembly 28. For example, the cutaway portion 80 may be cut or sanded down such that the pin assembly 28 may be welded onto the side of the adapter arm 26, as shown in FIG. 3. Alternatively, in some embodiments, the adapter arm 26 may further comprise additional holes for receiving bolts such that the pin assembly 28 may be bolted or otherwise mechanically attached to the adapter arm 26.

FIG. 6B depicts a side view of the adapter arm 26. In some embodiments, the adapter arm 26 has a total length, La, of about 10.3788 inches, as shown. Alternatively, embodiments are contemplated in which the length, La, ranges from about 9 inches to about 12 inches, or about 5 inches to 18 inches. In some embodiments, the through-hole 38 of the adapter arm 26 is positioned a length, Lh, from the end of the adapter arm 26. For example, in some embodiments, the length, Lh, is about 0.7688 inches. However, in some embodiments, the length, Lh, may range from about 0.6 inches to about 0.9 inches. In some embodiments, the length, Lh, may be selected based on the size and shape of the lug connector 24 of the tow bar assembly 14. In some embodiments, a diameter, Dh, of the through-hole 38 may be about 0.5375 inches. Embodiments are contemplated in which the diameter, Dh, ranges from about 0.4 inches to about 0.7 inches.

In some embodiments, the cutaway portion 80 of the adapter arm 26 may have an outer length, Lc, of about 1.9500 inches. In some embodiments, Lc, is about 1.0 inches to about 3.0 inches. Further, the cutaway portion 80 may comprise rounded edges such that a length, Ic, between the rounded edges is about 1.5750 inches. In some embodiments, Ic, is about 1.0 inches to about 3.0 inches. In some embodiments, the cutaway portion 80 is sized to receive the pin housing 40 of the pin assembly 28. Accordingly, embodiments are contemplated in which the length of the cutaway portion 80 corresponds to a length of the pin housing 40. In some embodiments, the cutaway portion 80 may be positioned a length, Lp, from the second end of the adapter arm 26, as shown. In some such embodiments, the length, Lp, may be about 2.8400 inches. In some embodiments, Lp, is about 1.0 inches to about 4.0 inches. However, embodiments are contemplated in which the length, Lp, may be altered, for example, based on a size and shape of the pin 42 and the connector portion 30 of the vehicle baseplate 18 such that, when connected, the pin 42 aligns into the recessed portion 52. Further, in some embodiments, the position of the cutaway portion 80 may be selected based on a location of the recessed portion 52 of the connector portion 30 of the vehicle baseplate 18.

In some embodiments, the locking portion 48 comprises a reduced diameter section having a length, Lr, of about 0.3450 inches. In some embodiments, Lr, is about 0.1 inches to about 0.5 inches. The locking portion 48 further comprises an increased diameter section having a width, WI, of about 1.500 inches. In some embodiments, WI, is about 1.0 inches to about 3.0 inches. In some embodiments, the width, WI, may be sized to fit and lock into the keyway 50 of the connector portion 30, as shown in FIG. 4A. In some embodiments, the keyway 50 of the connector portion 30 is designed with a similar shape as the locking portion 48 such that the width, WI, fits through the keyway 50 when the adapter arm 26 is positioned at a certain angle. Further, in some embodiments, the locking portion 48 is sized to produce a clearance fit within the keyway 50 such that the adapter arm 26 can be easily inserted into the keyway 50 at a range of angles. The increased diameter section may have a length, LI, of about 0.4800 inches. In some embodiments, LI, is about 0.2 inches to about 0.6 inches. The width, WI, is larger than the width, wl. In some embodiments, WI, is 1.5 times larger than the width, wl. In some embodiments, WI, is 2 times larger than the width, wl.

FIG. 6C depicts a front end view of the adapter arm 26. In some embodiments, the cutaway portion 80 of the adapter arm 26 has a depth, dc, of about 0.1250 inches, as shown. However, in some embodiments, the depth, dc, may range from about 0.1 inches to about 0.3 inches. Further, embodiments are contemplated in which the cutaway portion 80 comprises a smoothed surface for welding the pin assembly 28 onto the adapter arm 26. Accordingly, a variety of other shapes and sizes of the cutaway portion 80 are also contemplated (not shown).

It should be understood that, in some embodiments, the dimensions described herein may be altered. For example, in some embodiments, the size of the adapter arm 26 may be reduced or increased to fit a specific type of tow bar assembly or vehicle baseplate. In some embodiments, the dimensions of certain portions of the adapter arm 26 may be different than as described herein. For example, the length, Ls, of the slotted opening may be increased for receiving a lug connector having an increased length. Further, in some embodiments, a tolerance may be considered for each of the dimensions described herein such that the dimensions may be slightly different than those described herein. Further still, dimensions that are outside the ranges explicitly described herein are also contemplated.

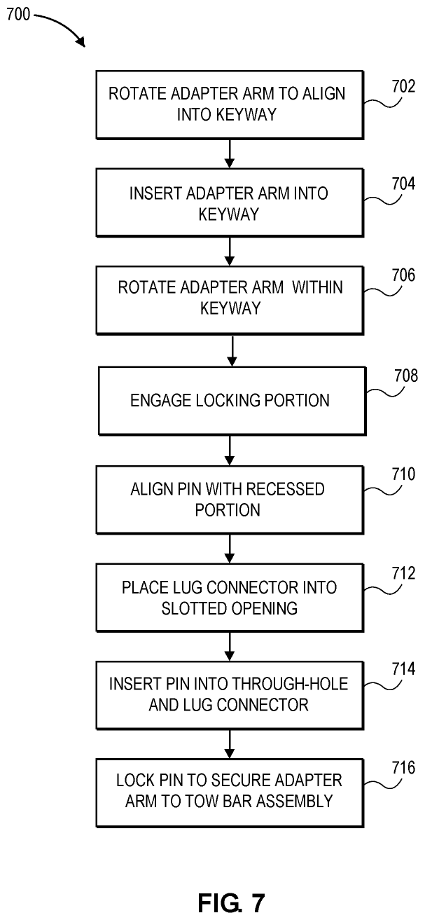

Turning now to FIG. 7, an exemplary method for connecting the adapter assembly 16 to the vehicle baseplate 18 and the tow bar assembly 14 relating to some embodiments of the invention. In some embodiments, it should be understood that the vehicle baseplate 18 may already be secured to the towed vehicle 20. For example, in some embodiments, the vehicle baseplate 18 may be bolted or welded to a front bumper or frame of the towed vehicle 20. At step 702 the adapter arm 26 is rotated such that the locking portion 48 fits through the keyway 50 of the connector portion 30 of the vehicle baseplate 18. In some embodiments, the locking portion 48 of the adapter arm 26 may be sized to fit within the keyway 50 at a predetermined angle. Accordingly, the adapter arm 26 may be rotated to achieve this predetermined angle. At step 704 the adapter arm 26 is inserted into the keyway 50. In some embodiments, the adapter arm 26 is inserted at least partially into the keyway 50 such that the locking portion 48 extends through the backside of the connector portion 30, as shown in FIG. 4A.

At step 706 the adapter arm 26 is rotated within the keyway 50. In some embodiments, the adapter arm 26 is rotated about 90 degrees from the initial predetermined angle of the adapter arm 26 when inserted into the keyway 50. At step 708 the locking portion 48 is engaged. In some embodiments, the rotation of the adapter arm 26 engages the locking portion 48. Here, in some embodiments, when engaged, the locking portion 48 temporarily prevents the adapter arm 26 from being removed from the keyway 50, as shown in FIG. 4A. For example, embodiments are contemplated in which the locking portion 48 prevents removal of the adapter arm 26 until the adapter arm 26 is rotated back to the initial predetermined angle.

At step 708 the pin 42 is aligned into the recessed portion 52 of the connector portion 30. In some embodiments, the pin 42 is aligned by rotating the adapter arm 26. Accordingly, in some embodiments, steps 706, 708, and 710 may occur simultaneously. For example, the adapter arm 26 may be rotated to engage the locking portion 48 and align the pin 42. In some embodiments, the pin 42 is biased such that the pin 42 is automatically engaged into the recessed portion 52 as the adapter arm 26 is rotated. For example, a spring may push the pin 42 into the recessed portion 52 once the adapter arm 26 has been rotated to align the pin 42 with the recessed portion 52.

At step 712 the lug connector 24 is placed within the slotted opening of the adapter arm 26 defined by the first prong 34 and the second prong 36. In some embodiments, a central lug of the lug connector 24 is positioned between the first prong 34 and the second prong 36. It should be understood that the lug connector 24 may comprise any number of lugs. For example, in some embodiments, the triple lug connector 60 comprising three lugs may be used. Alternatively, in some embodiments, the single lug connector 72 comprising a single lug connector may be used. At step 714 the clevis pin 68 is inserted into the through-hole 38 of the adapter arm 26 and the lug connector 24. Accordingly, in some embodiments, the lug connector 24 includes a hole for receiving the clevis pin 68. At step 716 the clevis pin 68 is locked using the cotter pin 70, which secures the connection of the adapter arm 26 and the tow bar assembly 14.

In some embodiments, the adapter arm 26 may be removed from the connector portion 30 by reversing at least a portion of the steps in method 700. For example, in some embodiments, to remove the adapter arm 26, the pin 42 may be retracted from the recessed portion 52, then the adapter arm 26 may be rotated to disengage the locking portion 48 such that the locking portion 48 fits through the keyway 50. Here, in some embodiments, the pin 42 may be removed by pulling the pin ring 44 with a force, F, as shown in FIG. 4B. Similarly, the adapter arm 26 may be disconnected from the tow bar assembly 14 by unlocking the cotter pin 70 from the clevis pin 68 and removing the clevis pin 68.

In some embodiments, the adapter arm 26 may be configured to replace one or more tow bar specific adapters. For example, in situations in which a variety of specific adapters may be needed the adapter arm 26 may be used to adapt the vehicle baseplate 18 to a variety of different types of tow bar assemblies. Further, embodiments are contemplated in which any number of the steps herein may be repeated or reversed for example, to remove the adapter assembly 16 from a first tow bar assembly and attach the adapter assembly 16 to a subsequent tow bar assembly.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A removable adapter arm for connecting a tow bar assembly to a vehicle baseplate, the adapter arm comprising:
a first end comprising a forked portion having a first prong and a second prong, the first prong and the second prong of the forked portion defining a slotted opening for receiving a lug connector of the tow bar assembly;
a through-hole extending through the first prong and the second prong, said through-hole configured to receive a connector pin to rotatably secure the first end of the adapter arm to the tow bar assembly; and
a second end comprising a locking portion configured to be inserted into a keyway of a connector portion and rotated to lock the second end of the adapter arm to the vehicle baseplate.

2. The adapter arm of claim 1, wherein the first prong and the second prong are configured to interface with a triple lug connector of the tow bar assembly such that a central lug of the triple lug connector fits into the slotted opening.

3. The adapter arm of claim 2, wherein the first prong and the second prong are further configured to interface with a single lug connector of the tow bar assembly such that a single lug of the single lug connector fits into the slotted opening.

4. The adapter arm of claim 1, further comprising:
a spring-loaded pin assembly disposed between the first end and the second end of the adapter arm for locking rotation of the adapter arm with respect to the connector portion, the spring-loaded pin assembly comprising:
a pin housing,
a pin disposed within the pin housing, and
a biasing spring secured to the pin housing for applying a biasing force to the pin thereby locking rotation of the adapter arm with respect to the connector portion when engaged,
wherein the pin is configured to lock rotation of the adapter arm by engaging with a recessed portion of the connector portion.

5. The adapter arm of claim 4,
wherein the locking portion is sized to fit within the keyway of the connector portion, and
wherein the pin of the spring-loaded pin assembly is engaged when the locking portion is rotated about 90 degrees after being placed through the keyway.

6. The adapter arm of claim 1, wherein the adapter arm comprises a single cylindrical bar.

7. The adapter arm of claim 1, wherein the adapter arm is configured to replace at least one tow bar-specific adapter between the vehicle baseplate and the tow bar assembly.

8. An adapter assembly for connecting a tow bar assembly to a vehicle baseplate, the adapter assembly comprising:
two adapter arms, each adapter arm comprising:
a first end comprising a forked portion having a first prong and a second prong, the first prong and the second prong of the forked portion defining a slotted opening for receiving a lug connector of the tow bar assembly;
a through-hole extending through the first prong and the second prong configured to receive a connector pin to rotatably secure the first end of the adapter arm to the tow bar assembly; and
a second end comprising a locking portion configured to be inserted into a keyway of a vehicle baseplate and rotated to lock the second end of the adapter arm to a connector portion of the vehicle baseplate; and
a pin assembly for each adapter arm disposed between the first end and the second end of the adapter arm for locking rotation of the adapter arm with respect to the vehicle baseplate.

9. The adapter assembly of claim 8, wherein the pin assembly comprises:
a pin housing,
a pin disposed within the pin housing, and
a biasing means secured to the pin housing for applying a biasing force to the pin thereby locking rotation of the adapter arm with respect to the vehicle baseplate when engaged.

10. The adapter assembly of claim 9, wherein the adapter arm further comprises a cutaway portion receiving the pin assembly therein.

11. The adapter assembly of claim 10, wherein the pin assembly is welded or permanently affixed to the cutaway portion of the adapter arm.

12. The adapter assembly of claim 8, wherein the first prong and the second prong are configured to interface with either of a triple lug connector or a single lug connector of the tow bar assembly.

13. The adapter assembly of claim 8,
wherein the locking portion is sized to fit within the keyway of the connector portion at a predetermined angle,
wherein the adapter arm is configured to be locked in place by rotating the adapter arm such that the locking portion temporarily prevents removal of the adapter arm.

14. The adapter assembly of claim 8, wherein the slotted opening is sized to receive an extended length of the lug connector of the tow bar assembly.

15. A towing adapter system comprising:
a tow bar assembly;
a vehicle baseplate adapted to be secured to a front end of a towed vehicle, the vehicle baseplate comprising:
a vehicle-specific attachment portion for securing the vehicle baseplate to the front end of the towed vehicle; and
a connector portion defining a keyway;
an adapter assembly for connecting the tow bar assembly to the vehicle baseplate, the adapter assembly comprising:
two adapter arms disposed between the tow bar assembly and the vehicle baseplate, each of the adapter arms comprising:
a first end comprising a forked portion having a first prong and a second prong, the first prong and the second prong of the forked portion defining a slotted opening for receiving a lug connector of the tow bar assembly;
a through-hole extending through the first prong and the second prong configured to receive a connector pin to rotatably secure the first end of the adapter arm to the tow bar assembly; and
a second end comprising a locking portion configured to be inserted into the keyway of a vehicle baseplate and rotated to lock the second end of the adapter arm to the connector portion of the vehicle baseplate; and
a pin assembly for each adapter arm disposed between the first end and the second end of the adapter arm for locking rotation of the adapter arm with respect to the connector portion.

16. The system of claim 15,
wherein the tow bar assembly comprises a triple lug connector including a first outer lug, a second outer lug, and a central lug, and
wherein the first prong and the second prong are configured to interface with the triple lug connector of the tow bar assembly such that the central lug of the triple lug connector fits into the slotted opening.

17. The system of claim 15,
wherein the tow bar assembly comprises a single lug connector including a single lug, and
wherein the first prong and the second prong are configured to interface with the single lug connector of the tow bar assembly such that the single lug fits into the slotted opening.

18. The system of claim 15, wherein the adapter arm is configured to replace one or more tow-bar specific adapters for connecting the tow bar assembly and the vehicle baseplate.

19. The system of claim 15,
wherein the locking portion is sized to fit within the keyway of the connector portion when the adapter arm is positioned at a predetermined angle, and
wherein the pin of the pin assembly is engaged when the locking portion is rotated about 90 degrees from the predetermined angle after being placed through the keyway.

20. The system of claim 15,
wherein the adapter arm further comprises a cutaway portion on a central portion of the adapter arm for receiving the pin assembly, and
wherein the pin assembly is permanently attached to the cutaway portion of the adapter arm.
